(19) United States
(12) Patent Application Publication
(10) Pub. No.: US 2024/0100549 A1
(43) Pub. Date: Mar. 28, 2024

(54) MIXING SYSTEM FOR POWER WASHER

(71) Applicant: Walbro LLC, Cass City, MI (US)

(72) Inventors: Bradley J. Roche, Millington, MI (US); Eric G. Zbytowski, Caro, MI (US); Cyrus M. Healy, Ubly, MI (US); Benjermen L. Hill, Bay City, MI (US); Elizabeth M. VanSipe, Caro, MI (US)

(21) Appl. No.: 18/373,820

(22) Filed: Sep. 27, 2023

Related U.S. Application Data
(60) Provisional application No. 63/410,400, filed on Sep. 27, 2022.

(51) Int. Cl. B05B 7/04; B01F 25/00; B08B 3/02; B08B 13/00

(52) U.S. Cl. CPC B05B 7/0408; B01F 25/1051; B08B 3/026; B08B 13/00; B01F 2101/4505; B08B 2203/0217

(57) ABSTRACT

A mixing system for a power washer includes an electrically actuated valve communicated with a supply of a working fluid, and having a valve head that is movable between open and closed positions to control the flow rate of the working fluid through an outlet of the valve. The outlet of the valve is communicated with a fluid passage of the power washer to enable flow of the working fluid into a primary fluid and discharge of a mixture of the primary fluid and working fluid from the power washer when the valve is open, and to provide a flow of primary fluid from the power washer when the valve is closed.

### Reference to Related Applications

This application claims the benefit of U.S. Provisional Application Ser. No. 63/410,400 filed on Sep.27, 2022 the entire content of which is incorporated herein by reference in its entirety.

### TECHNICAL FIELD

The present disclosure relates generally to a system for mixing, for example a cleaner and water, for delivery of the mixture from a nozzle of a power washer.

### BACKGROUND

Power washers can provide a high-pressure output of water and optionally a washing fluid or detergent. The flow rate of the washing fluid is dependent upon the flow rate of the water and may vary as a function of the viscosity of the washing fluid. This arrangement can waste washing fluids for which a lower flow rate is effective and can be less effective than desired for washing fluids requiring a higher flow rate.

### SUMMARY

In at least some implementations, a mixing system for a power washer includes an electrically actuated valve communicated with a supply of a working fluid, and having a valve head that is movable between open and closed positions to control the flow rate of the working fluid through an outlet of the valve. The outlet of the valve is communicated with a fluid passage of the power washer to enable flow of the working fluid into a primary fluid and discharge of a mixture of the primary fluid and working fluid from the power washer when the valve is open, and to provide a flow of primary fluid from the power washer when the valve is closed.

In at least some implementations, a housing is provided that has an inlet through which the working fluid enters the housing, the housing carries multiple electrically actuated valves, each of the electrically operated valves has a separate outlet and each of the separate outlets communicates with a branch passage of the housing, and wherein the branch passage leads to a housing outlet from which working fluid is discharged from the housing. In at least some implementations, a controller is provided and each of the electrically actuated valves is connected to the controller and separately actuated by the controller. In at least some implementations, the housing outlet is connected to a supply of the primary fluid so that working fluid that flows through the housing outlet is combined with a flow of the primary fluid.

In at least some implementations, a controller is provided and the electrically actuated valve is connected to the controller and actuated by the controller. In at least some implementations, the control system includes a wireless communication device adapted to pair with a remote device to receive instructions from the remote device that alter control of the electrically actuated valve. In at least some implementations, a battery is electrically coupled to the electrically actuated valve via the controller. In at least some implementations, the controller includes instructions by which the signal provided by the controller to the electrically actuated valve varies as a function of the voltage of the battery.

In at least some implementations, a power washer includes a primary driver, a reservoir including a supply of a working fluid, a primary fluid inlet through which a supply of a primary fluid is received, a mixing valve, a fluid passage, a nozzle and a controller. The mixing valve is electrically actuated and has an inlet communicated with the reservoir and an outlet through which a metered flow of the working fluid exits the mixing valve. The fluid passage communicates with the primary fluid inlet and with the outlet of the mixing valve. The nozzle communicates with the fluid passage and from which fluid is discharged. And the controller is coupled to the mixing valve and operable to cause movement of a valve head of the mixing valve to change the flow rate of the working fluid to the fluid passage.

In at least some implementations, an electric power supply is provided and electric power for operation of the controller and the mixing valve is provided from the power supply. In at least some implementations, the electric power supply is a battery that is carried by a stand of the power washer. In at least some implementations, the controller varies the operation of the mixing valve as a function of a voltage of the battery.

In at least some implementations, a stand is provided to which the reservoir is mounted, the stand has a pair of spaced apart feet and a support plate coupled to the feet and to the reservoir. In at least some implementations, a power unit is coupled to one or both of the stand and the reservoir, the power unit includes the controller and a battery that provides electrical power to the controller and to the mixing valve. In at least some implementations, the mixing valve is carried by a housing, the housing is carried by one or both of the stand and the reservoir, and the housing has an inlet through which working fluid flows to the mixing valve and the housing has an outlet from which working fluid is discharged and flows to the fluid passage.

In at least some implementations, a wireless communication device is coupled to the controller and arranged to wireless couple with a remote device to permit communication between the remote device and the controller. In at least some implementations, the controller includes memory with instructions by which the operation of the mixing valve is changeable via inputs received from the remote device.

In at least some implementations, the controller varies the operation of the mixing valve as a function of a voltage of the battery.

In at least some implementations, the mixing valve is a solenoid valve having an armature that is movable in response to electricity applied to the valve.

In at least some implementations, a support frame to which the primary driver is mounted, and wherein the stand is separate from the support frame.

In at least some implementations, the mixing valve is a first mixing valve and wherein a second mixing valve is provided, and the second mixing valve is also electrically actuated and carried by the housing, wherein the housing includes a branch passage that communicates with the outlet of the first mixing valve and an outlet of the second mixing valve, and the branch passage communicates with the housing outlet.

The power washer may include one or more electrically operated mixing valves that permit a varied flow of a working fluid into a flow of a primary fluid to provide a desired output fluid for washing a surface. The power washer may include a stand that conveniently holds one or more of a reservoir of the working fluid, the mixing valve(s) and a power unit which may include a controller and an electrical interface for the controller which may include a battery. The system may be arranged for wireless communication of a remote device with the controller to permit a user to adjust the settings by which the control operates the mixing valve, according to the desires of the user. The settings adjustments may be made by way of a software interface provided on the remote device, or the settings control interface may be provided on a device carried by the power washer (e.g. a touch screen display or other input device).

The mixing valve(s) described herein can, if desired, be operated at different frequencies or intervals, such as by a pulse-width modulated control. Further, in at least some implementations, an actuator may be coupled to the nozzle to selectively permit and prevent flow through the nozzle, and the mixing valve is controlled as a function of a pattern of actuation of the actuator. By way of an example, the actuator may be a trigger or lever on a handle of the nozzle assembly, and a user may actuate the actuator to permit flow through the nozzle by opening a valve associated with the nozzle, and a user may release the actuator to cause the associated valve to close and thereby shutoff flow to the nozzle.

### BRIEF DESCRIPTION OF THE DRAWINGS

The following detailed description of certain embodiments and best mode will be set forth with reference to the accompanying drawings, in which:

FIG. 1 is a perspective view of a power washer connected to a supply of a working liquid, which may be a liquid cleaning agent and including a mixing system;

FIG. 2 is a front view of the supply of working liquid, including a reservoir, and a stand for the reservoir and mixing system;

FIG. 3 is a perspective view of the stand;

FIG. 4 is a perspective view of mixing valves coupled to a housing with supply passages formed therein;

FIG. 5 is a perspective view of the mixing valves and housing;

FIG. 6 is a sectional view of the housing;

FIG. 7 is another sectional view of the housing;

FIG. 8 is a perspective view of a mixing valve assembly;

FIG. 9 is a perspective view of a housing for a control module;

FIGS. 10, 11, 12, 13, 14 and 15 are screenshots of a mobile device showing an application that may be used to control the mixing system remotely, via the mobile device.

### DETAILED DESCRIPTION

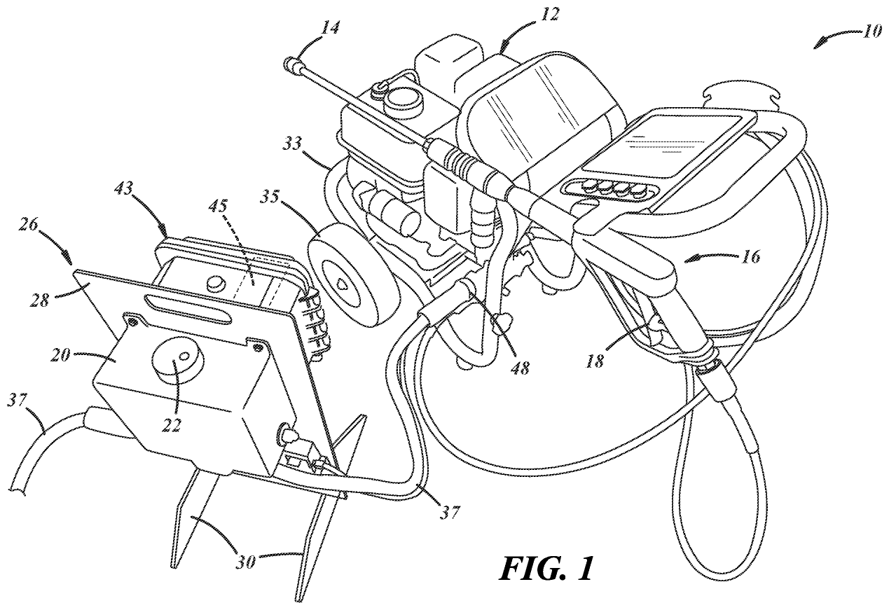

Referring in more detail to the drawings, FIG. 1 shows a power washer 10 which may have a primary driver 12 such as a combustion engine or an electric motor that is operable to increase the pressure of an inlet, primary liquid, such as water, and to discharge that liquid under pressure such as through a nozzle 14. The nozzle 14 may be part of a handheld device 16 including a trigger 18 for user control of when liquid is discharged from the nozzle 14.

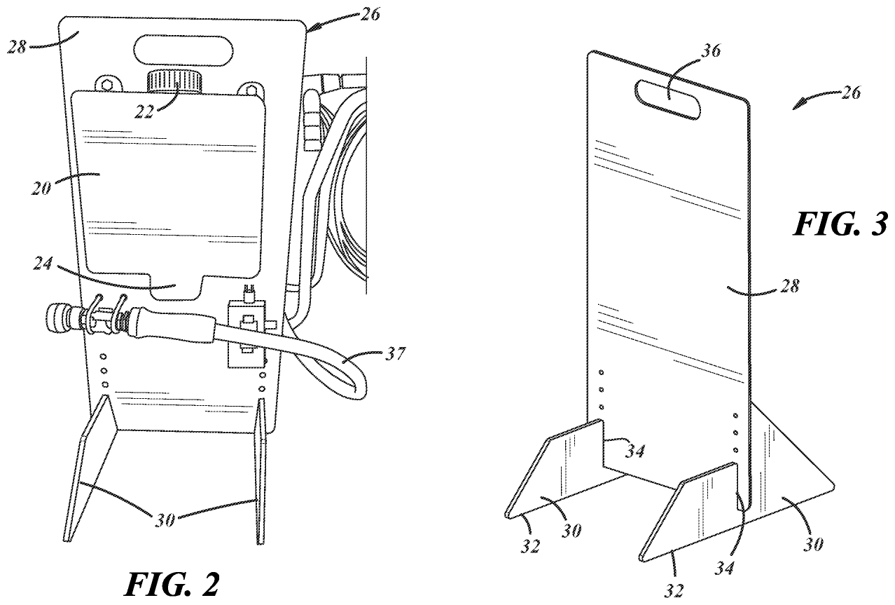

In at least some implementations, such as is shown in FIGS. 1 and 2, the power washer 10 is coupled to a supply of a working liquid, which may be a cleaning agent or other solution, as desired. The working liquid may be stored in a reservoir 20 of any desired size and having an inlet 22 through which additional working liquid may be added to the reservoir 20 and an outlet 24 from which the working liquid exits the reservoir.

As shown in FIGS. 1-3, the reservoir 20 may be coupled to a stand 26 which may have a support plate 28 received in one or more feet 30 to maintain the support plate 28 in an upright position, and the reservoir 20 at a desired location (e.g. height relative to a ground surface, and/or position relative to the power washer). In the example shown, two feet 30 have a bottom surface 32 adapted to be received on the ground surface, and slots 34 (FIG. 3) open through the feet opposite to the ground and adapted to receive the support plate 28. The stand 26 may be low-cost, and formed in one-piece or of multiple pieces of stamped, bent or otherwise simply formed metal material, or molded from plastic. The support plate 28 may include a handle 36, which may be defined by material surrounding an opening in the plate 28. The reservoir 20 may include a manual or electrically actuated drain valve, and a filter may be provided to remove contaminants from the system, if desired. Further, as shown in FIG. 1, the power washer 10 may include a support frame 33 to which the primary driver 12 is mounted, and which may include wheels 35. The support frame 33 may be separate from the stand 26, in at least some implementations. If desired, the stand 26 may include wheels.

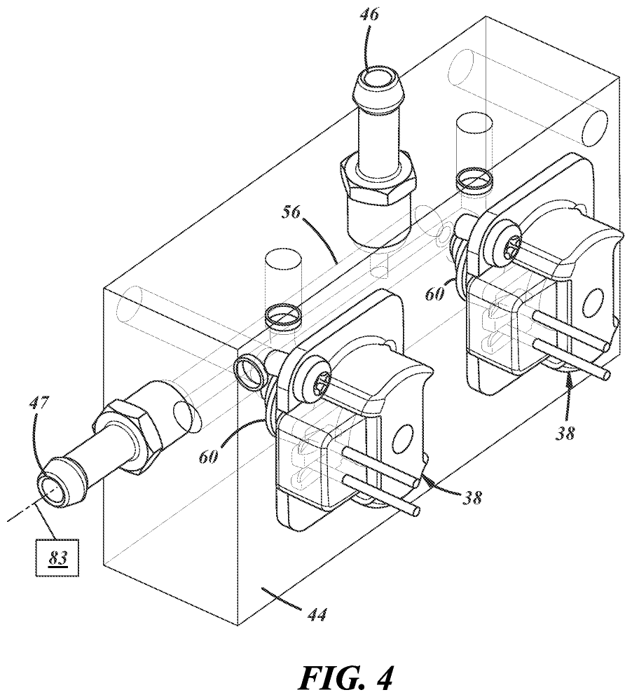

To control the flow of the working liquid with the primary liquid which flows through one or more fluid passages or tubes 37, the mixing system may include one or more control valves 38. As shown in FIGS. 4, 5 and 8, each valve 38 may be an electrically actuated valve, such as a solenoid valve. The control valves 38 may be constructed and arranged as set forth in U.S. Pat. No. 11,255,457 and U.S. patent application Ser. No. 17/963,025, which are incorporated herein by reference, or otherwise as desired. Representative valves 38 are shown in FIGS. 4, 5 and 8. An armature or other valve head 40 may be electronically controlled and movable to selectively close off a valve outlet 42 to prevent flow of the working fluid through the valve 38, and to open the valve outlet 42 and permit flow of the working fluid through the valve 38. The valves 38 may be cycled between open and closed positions to control the flow rate of working fluid therethrough, or the position of the armature or valve head 40 may be adjustable/variable to permit control of the flow rate based upon the extent to which the armature or valve head 40 is open. When closed, the primary fluid (e.g. water) may still flow to the pressure washer 10 to permit only or substantially only the primary fluid to be discharged from the nozzle 14, when desired. This may facilitate rinsing or washing a surface without flow of the working fluid, as well as purging or cleaning out working fluid from the passages/hoses of the power washer 10.

Additionally or instead, the valves 38 may be driven between open and closed positions at a different frequencies or intervals, to vary the flow rate therethrough. Such control may be done via pulse-width modulated signals, or otherwise as desired. When multiple control valves 38 are used and controlled in this way, a wide range of proportional flow rates can be achieved and a significant turn down or reduction ratio from peak flow can be achieved.

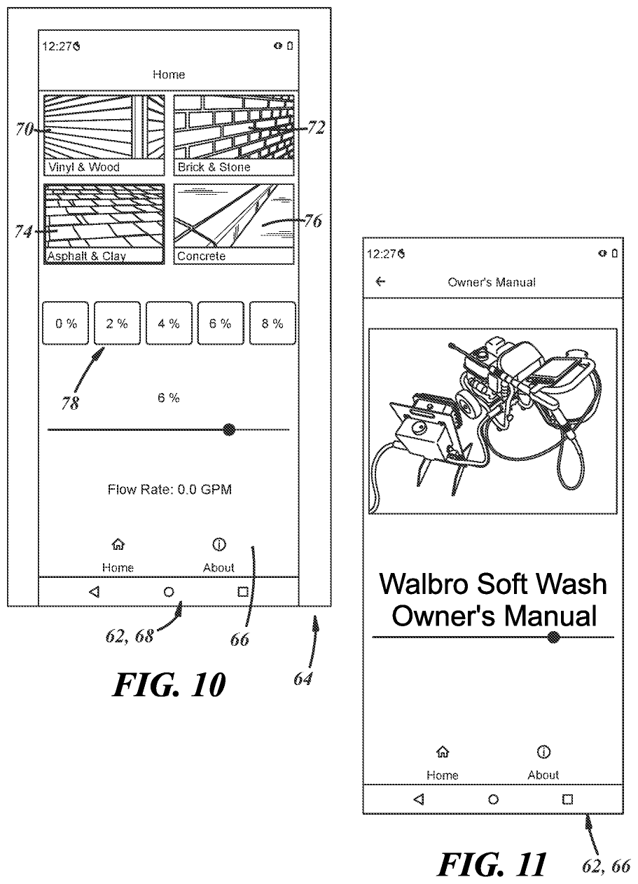

Further, in at least some implementations, an actuator (e.g. trigger 18) may be coupled to the nozzle 14 to selectively permit and prevent flow through the nozzle 14, and the mixing/control valve 38 is controlled as a function of a pattern of actuation of the trigger 18. By way of an example, more frequent actuation of the trigger over a certain time period may cause the system to open the control valve(s) 38 more frequently to permit greater flow therethrough, and vice versa. Of course, other control schemes may be initiated as a function of user actuation of the nozzle/trigger to provide a varied flow rate as a function of the use of the power washer without requiring a user to manipulate settings related to the control valve. In at least some implementations, a control strategy could be implemented based on a user actuating the trigger 18 in an ON-OFF (e.g. opened/closed nozzle) combination to select a desired ratio of working liquid to primary liquid, similar to selection of a ration from a user interface on the power washer or a remote device (e.g. as shown in FIG. 10). This way a user can be located away from the power washer, or not need to put down the nozzle to operate a remote device, and still change/select the liquid ratio. The selected ratio may include little or no working liquid and substantially or only primary liquid, such as to rinse a surface with water.

In at least some implementations, to control the valve(s) 38 as a function of user control of the nozzle/trigger, the system may have a flow sensor that is response to actuation of the nozzle and subsequent liquid flow. The sensor and control system can determine the actuation/flow and have times set in the controller to match the pattern of trigger actuation. So the system, in such an example, could use a combination of time that the primary liquid is flowing (e.g. when the trigger is actuated) as well as a pattern of how often the primary water is flowing—which could be related to a mixture or liquid ratio setting stored in the controller, such as in a look-up table or other data set. The user can determine the settings by information provided to the user, such as in an operator's manual or even on a label of the power washer 10.

Electricity may be provided to the valves via a power unit 43 (FIG. 1) that may be carried by the stand 26 and/or the reservoir 20. The power unit 43 may be coupled to a power source which may include an electrical outlet of a building, an on-board battery 45 or electrical power may be generated by a combustion engine 12 of the power washer 10 which includes or drives an electrical generator and/or alternator, in known manner, or otherwise provides electrical power such as from power generated by a magneto ignition system of the engine. The power unit 43 may provide power to both the valves 38 and to an electric motor of the power washer 10 when the primary driver 12 of the power washer is an electric motor. In this way, the electricity needed for operating the power washer may all be provided from a source and through the power unit 43.

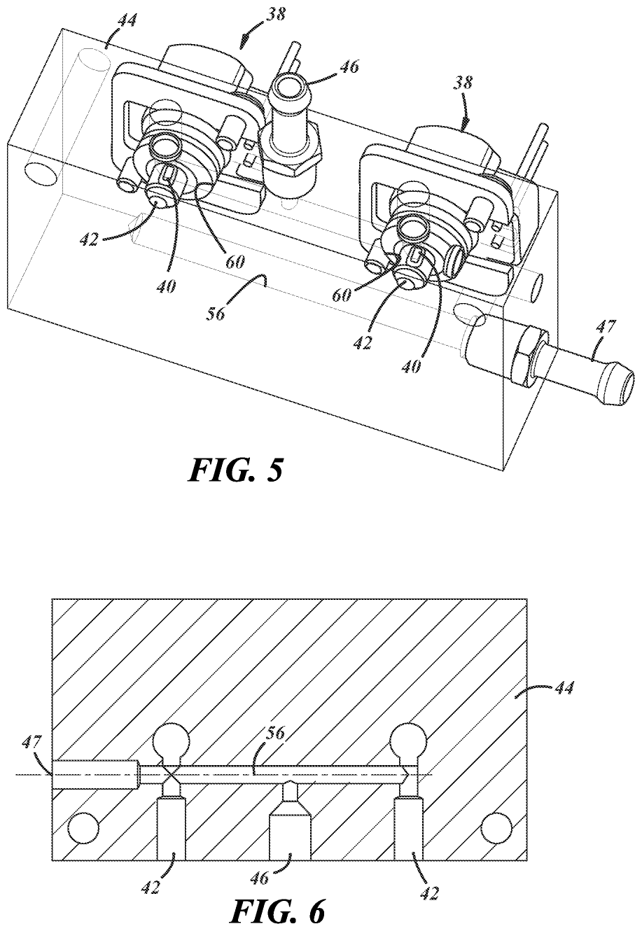

As shown in FIGS. 4 and 5, the control valves 38 may be coupled to a housing 44 that may be carried by the reservoir 20. The housing has an inlet 46 through which fluid flows from the reservoir 20 into the housing, and the housing has an output 47 that is coupled to a working fluid inlet 48 (FIG. 1) of the power washer 10. Working fluid that enters the inlet 48 may be combined in any desired manner with the primary fluid. As non-limiting examples, a pump (electrically or mechanically actuated) may actively pump the working fluid into the flow of primary fluid, or a venturi may be provided via which the working fluid is drawn into or entrained into the flow of primary fluid.

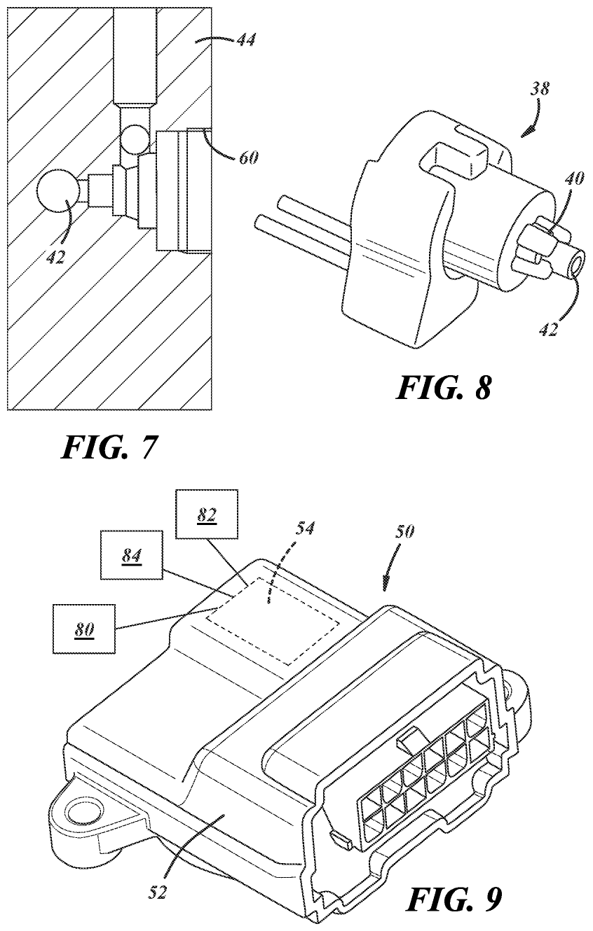

At least when more than one valve 38 is provided, the housing 44 may define a manifold or distribution block that may include a branch passage 56 coupling together the outlets 42 of each valve 38 and providing a combined flow of working fluid from each valve to the outlet 47 so that the working fluid can be combined with the primary fluid before being discharged from the nozzle 14 of the power washer 10. The housing 44 is shown in FIGS. 4-7, and may include separate cavities or sockets 60 into which the valves 38 extend, and flow paths as noted. The housing 44 may be separate from the reservoir 20 and coupled to the reservoir 20 or to the stand 26, or the housing 44 may be integrally formed in the material of the reservoir 20 (which may be plastic or metal or a composite), by way of non-limiting examples.

FIG. 9 shows a control module 50 which may be carried in or by the power unit 43 and have an outer housing 52 and a controller 54 on a circuit board within the housing 52. The valve(s) 38 may be coupled to the controller 54, and the controller 54 may be responsive to provide electricity to the valve(s) 38 to control the valves 38 and provide a desired flow of the working fluid.

In the case of an on-board battery, the power unit 43 may include a battery monitoring arrangement and provide a low voltage warning when the battery power is reduced, which may affect operation of the power washer. The controller may change the signal(s) provided to the control valves 38 when battery power is reduced to compensate for the effect lower electrical power has on performance of the valve(s) 38. In this way, the controller includes instructions (e.g. stored on memory communicated with the controller) by which the signal provided by the controller to the electrically actuated valve may be varied as a function of the voltage of the battery, in at least some implementations.

FIGS. 10-15 show one implementation of an application 62 that may be stored on and used from a mobile device 64, like a phone or tablet. The application may facilitate user control of the mixing valve or valves 38, to provide a desired flow rate of the working fluid and a desired concentration of the working fluid within the mixture with the primary fluid. While shown as a screen 66 of a mobile device 64, the power washer 10 may include a display screen and information may be provided by the controller 54, which may include suitable memory with suitable programming. The information may include menus or other options that are selectable by a user via suitable inputs (e.g. buttons, dials, switches or touch-screen portions).

FIG. 10 shows an example of a home screen 68 from which a user may select one or more control schemes based on, for example, a desired concentration of the working liquid (shown as a percentage of the mixture, with 6% highlighted/selected in FIG. 10), and/or an application. In this example, the application is based upon the type of material being cleaned by the power washer 10 with representative examples including, and icons 70-76 provided for vinyl or wood 70, brick or stone 72, asphalt or clay 74 and concrete 76, and icons 78 for different flow rates of the working fluid. Of course, fewer or a greater number of options may be provided as desired. It is noted that the pressure washer 10, the mixing system or both may include a flow rate sensor 80 (FIG. 9), and output from such sensor(s) maybe communicated to the user via the application 62 and the mobile device display 66 so that the user can see the flow rate of the primary liquid, working liquid, both, and/or the flow rate of the mixture including both the primary liquid and working liquid. The output of the sensor(s) 80 may be used to provide feedback control of the mixing system (e.g. feedback control of the valve or valves that control flow of the working fluid).

FIG. 11 shows a screenshot of the mobile device display 66 including a title page of an owner's manual for the power washer 10 including the mixing system, and the application may include the entire owner's manual or portions thereof, as desired.

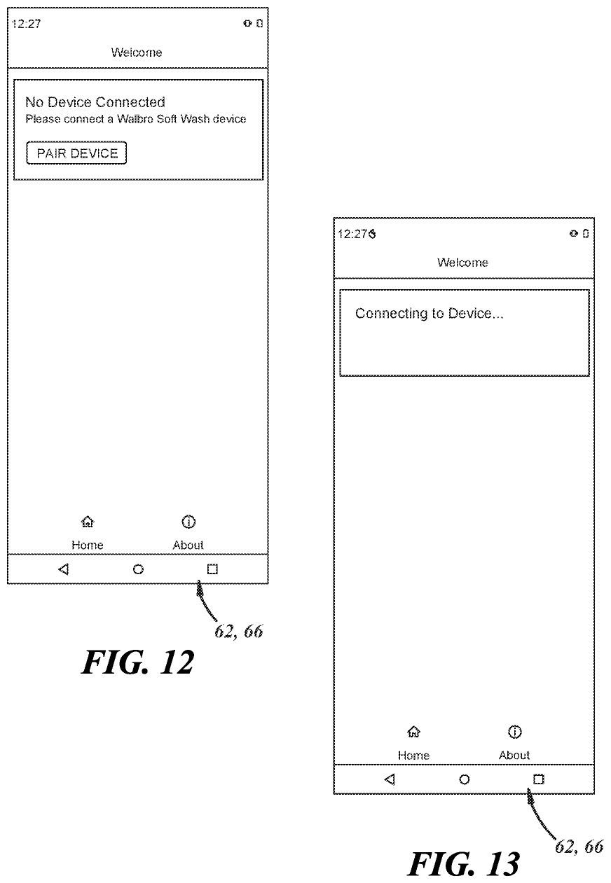

FIG. 12 shows a screenshot of the mobile device display 66 via which a user may pair or connect their mobile device 64 with the controller 54, such as via any desired wireless protocol including but not limited to Wi-Fi Bluetooth, and/or cellular protocols. In this way, the controller 54 includes a wireless communication device 82 (FIG. 9) via which control commands for the power washer 10 can be received and executed by the controller 54. FIG. 13 shows a screenshot of the mobile device display 66 including a message alerting a user that the application is attempting to connect a device 64 to the power washer controller 54.

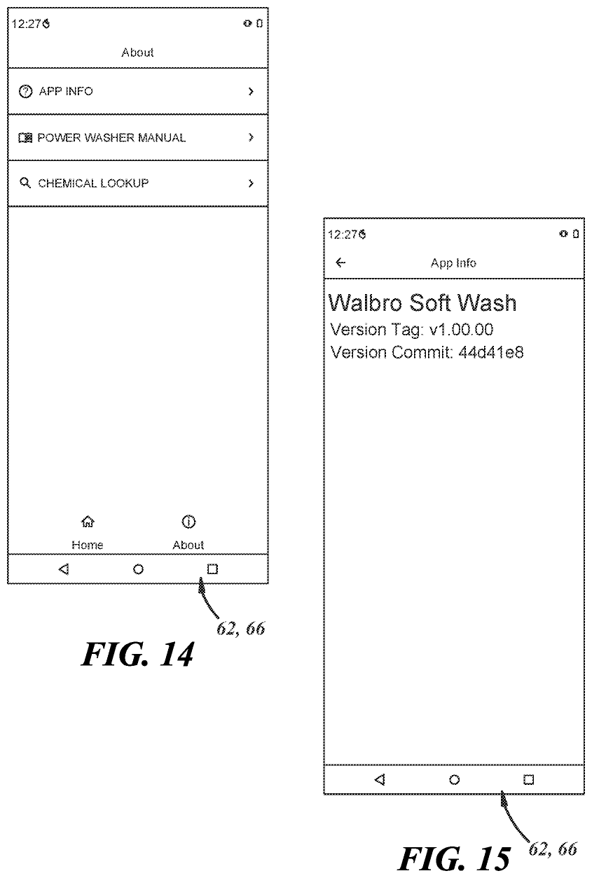

FIG. 14 shows an “About” screen of the application 62 from which a user may choose to view information about the application, shown in FIG. 15, a user manual, shown in FIG. 11, or a search interface from which a user may look-up the type of working fluid desired to be used. The flow rate of a working fluid may be dependent upon the type of working fluid being used and based upon one or more characteristics of that working fluid, including the chemicals thereof and/or the concentration or strength of the fluid being used, among other factors. The application 62 may include programming to enable control of the mixing valve(s) 38 that may be customized and may be adjustable for different working fluids. That is, to clean concrete with one fluid may provide a different flow rate for a first variety of working fluid than for a second variety of working fluid. The application may simplify control of the mixing/control valves 38 by enabling the user to choose the working fluid being used and having the application provide the recommended mixture of working fluid and primary fluid. The application may also permit the user to change the recommended mixture or otherwise provide a customized mixture, as desired.

The mixing system may be used with any high-pressure power washer. The mixing system permits selective application of the working fluid to wash a surface, and the system terminates application of the working fluid so that the surface may be rinsed with the primary fluid when desired, without requiring manual control of a valve, although manual control may be permitted if desired. The mixing system provides a mixture of the working fluid to an inlet of the power washer, is compatible with standard and high reach nozzles, is self-contained, may include a rechargeable battery to power the controller and valve(s), enables use with different working fluids and permits selection of chemical concentrations, can be controlled by cell phone or tablet application with Bluetooth or other wireless connectivity protocol; can control the flow rate of working fluid as a function of the flow rate of the primary fluid, and may utilize relatively simply solenoid valves to control the fluid flow in the system.

The system may also use corded or cordless power (e.g. battery 45), and the battery 45 may be any desired configuration and construction. The system may include a learning mode that enables a user to store or retain a desired concentration for a working fluid, with a particular power washer. The system may include a valve 83 (FIG. 4) that controls air flow into the output, and the air may help clean or purge passages or conduits from the working fluid source, or may provide a so-called “foam mode” in which a detergent is foamed by addition of air. The mixing system may permit water flow for cleaning or purging of passages and conduits from the working fluid source. The mixing system may include a liquid level sensor 84 (FIG. 9) that monitors the level of liquid in the reservoir and which may provide a low-level warning to a user. Similarly, battery or other power source may be monitored and a low battery or low power warning provided to a user. The application may change the actuation of the mixing valves 38 when the battery voltage of other power supply level changes, and to provide desired operation over a wide range of voltages (e.g. some systems may use 14 v, 18 v, 20 v, etc). The valves 38 may be controlled to automatically function upon sensed flow of the primary liquid, such that no on/off switch is needed for the mixing system, in at least some implementations. The user interface/application may include an operator manual or link to an online/internet-based manual, and may include a library of working fluid information or link to an online/internet-based library of such information, along with recommended concentrations of mixtures using such working fluids.

The forms of the invention herein disclosed constitute presently preferred embodiments and many other forms and embodiments are possible. It is not intended herein to mention all the possible equivalent forms or ramifications of the invention. It is understood that the terms used herein are merely descriptive, rather than limiting, and that various changes may be made without departing from the spirit or scope of the invention.

1. A mixing system for a power washer, comprising:
an electrically actuated valve communicated with a supply of a working fluid, the valve having a valve head that is movable between open and closed positions to control the flow rate of the working fluid through an outlet of the valve, wherein the outlet of the valve is communicated with an inlet of the power washer to enable flow of the working fluid into a primary fluid and discharge of a mixture of the primary fluid and working fluid from the power washer when the valve is open, and to provide a flow of primary fluid from the power washer when the valve is closed.

2. The mixing system of claim 1 which includes a housing having an inlet through which the working fluid enters the housing, the housing carries multiple electrically actuated valves, each of the electrically operated valves has a separate outlet and each of the separate outlets communicates with a branch passage of the housing, and wherein the branch passage leads to a housing outlet from which working fluid is discharged from the housing.

3. The mixing system of claim 2 which also includes a controller and wherein each of the electrically actuated valves is connected to the controller and separated actuated by the controller.

4. The mixing system of claim 2 wherein the housing outlet is connected to a supply of the primary fluid so that working fluid that flows through the housing outlet is combined with a flow of the primary fluid.

5. The mixing system of claim 1 which also includes a controller and wherein the electrically actuated valve is connected to the controller and actuated by the controller.

6. The mixing system of claim 5 wherein the electrically actuated valve is controlled by a pulse-width modulated signal.

7. The mixing system of claim 5 wherein the control system includes a wireless communication device adapted to pair with a remote device to receive instructions from the remote device that alter control of the electrically actuated valve.

8. The mixing system of claim 5 which also includes a battery electrically coupled to the electrically actuated valve via the controller.

9. The mixing system of claim 8 wherein the controller includes instructions by which the signal provided by the controller to the electrically actuated valve varies as a function of the voltage of the battery.

10. A power washer, comprising:
a primary driver;
a reservoir including a supply of a working fluid;
a primary fluid inlet through which a supply of a primary fluid is received;
a mixing valve that is electrically actuated and has an inlet communicated with the reservoir and an outlet through which a metered flow of the working fluid exits the mixing valve;
a fluid passage communicating with the primary fluid inlet and with the outlet of the mixing valve;
a nozzle communicating with the fluid passage and from which fluid is discharged; and
a controller coupled to the mixing valve and operable to cause movement of a valve head of the mixing valve to change the flow rate of the working fluid to the fluid passage.

11. The power washer of claim 10 which includes an electric power supply and wherein electric power for operation of the controller and the mixing valve is provided from the power supply.

12. The power washer of claim 11 wherein the electric power supply is a battery that is carried by a stand of the power washer.

13. The power washer of claim 10 which also includes a stand to which the reservoir is mounted, the stand having a pair of spaced apart feet and a support plate coupled to the feet and to the reservoir.

14. The power washer of claim 13 which also includes a power unit coupled to one or both of the stand and the reservoir, the power unit including the controller and a battery that provides electrical power to the controller and to the mixing valve.

15. The power washer of claim 14 wherein the mixing valve is carried by a housing, the housing is carried by one or both of the stand and the reservoir, and the housing has an inlet through which working fluid flows to the mixing valve and the housing has an outlet from which working fluid is discharged and flows to the fluid passage.

16. The power washer of claim 10 which also includes a wireless communication device coupled to the controller and arranged to wireless couple with a remote device to permit communication between the remote device and the controller.

17. The power washer of claim 16 wherein the controller includes memory with instructions by which the operation of the mixing valve is changeable via inputs received from the remote device.

18. The power washer of claim 14 wherein the controller varies the operation of the mixing valve as a function of a voltage of the battery.

19. The power washer of claim 10 wherein the mixing valve is a solenoid valve that is controlled by a pulse-width modulated signal.

20. The power washer of claim 13 which includes a support frame to which the primary driver is mounted, and wherein the stand is separate from the support frame.

21. The power washer of claim 15 wherein the mixing valve is a first mixing valve and wherein a second mixing valve is provided, and the second mixing valve is also electrically actuated and carried by the housing, wherein the housing includes a branch passage that communicates with the outlet of the first mixing valve and an outlet of the second mixing valve, and the branch passage communicates with the housing outlet.

22. The power washer of claim 10 which also includes an actuator coupled to the nozzle to selectively permit and prevent flow through the nozzle, and wherein the mixing valve is controlled as a function of a pattern of actuation of the actuator.
